(19) United States
(12) Patent Application Publication
(10) Pub. No.: US 2010/0039728 A1
(43) Pub. Date: Feb. 18, 2010

(54) METHOD OF DETECTING POSITION OF HEAD AND STORAGE APPARATUS

(75) Inventor: Hiroyuki Suzuki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/472,917

(22) Filed: May 27, 2009

(30) Foreign Application Priority Data
Aug. 14, 2008 (JP) 2008-208823

(51) Int. Cl. G11B 5/55

(52) U.S. Cl. 360/78.01; G9B/5.182

(57) ABSTRACT

A relative movement is induced between a head and first and second recording tracks along the boundary between the first recording track and the second recording track. The first recording track includes first magnetic dots arranged in the down-track direction at constant intervals. The second recording track includes second magnetic dots arranged in the down-track direction at constant intervals identical to the intervals of the first magnetic dots. The second magnetic dots are dislocated in the down-track direction relative to the first magnetic dots. The positional information is generated to specify the position of the head based on the difference between a first output of signals read from the first magnetic dots and a second output of signals read from the second magnetic dots.

### CROSS-REFERENCE TO RELATED APPLICATION

This application is based upon and claims the benefit of priority from the prior Japanese Patent Application No. 2008-208823 filed on Aug. 14, 2008, the entire contents of which are incorporated herein by reference.

### FIELD

The embodiment discussed herein is related to a storage apparatus configured to position a head relative to a recording track formed on a storage medium.

### BACKGROUND

A so-called bit-patterned medium is well known. The bit-patterned medium defines parallel recording tracks extending in the circumferential direction, namely the down-track direction, of a magnetic recording disk, for example. The individual recording track includes magnetic dots arranged in the down-track direction. The magnetic dots of the adjacent recording tracks are arranged in a zigzag or staggered pattern along a boundary between the adjacent recording tracks. A read element follows the adjacent recording tracks to simultaneously read binary data from the magnetic dots of the adjacent recording tracks.

The read element deviates from a predetermined movement path in response to the vibration of the magnetic recording disk, for example. The read element is thus accidentally positioned above the recording track next to the target adjacent recording tracks. Binary data is read from the recording track other than the target adjacent recording tracks. Binary data cannot be read with accuracy.

### SUMMARY

According to an aspect of the invention, a method of detecting the position of a head, includes: making a relative movement between a head and first and second recording tracks along the boundary between the first recording track and the second recording track, the first recording track including first magnetic dots arranged in the down-track direction at constant intervals, the second recording track including second magnetic dots arranged in the down-track direction at constant intervals identical to the intervals of the first magnetic dots, the second magnetic dots being dislocated in the down-track direction relative to the first magnetic dots; and generating positional information specifying the position of the head based on the difference between a first output of signals read from the first magnetic dots and a second output of signals read from the second magnetic dots.

According to another aspect of the invention, a storage apparatus includes: a storage medium including a first recording track and a second recording track adjacent to the first recording track, the first recording track including first magnetic dots arranged in the down-track direction at constant intervals, the second recording track including second magnetic dots arranged in the down-track direction at constant intervals identical to the intervals of the first magnetic dots, the second magnetic dots being dislocated in the down-track direction relative to the first magnetic dots; a head opposed to the storage medium, the head configured to read signals from the first and second magnetic dots; a driving mechanism supporting the head, the driving mechanism moving the head in the cross-track direction of the first and second recording tracks; and a controller circuit determining the difference between a first output of the signals read from the first magnetic dots and a second output of the signals read from the second magnetic dots, the first and second outputs being supplied from the head moving relative to the storage medium along the boundary between the first recording track and the second recording track, the controller circuit controlling the operation of the driving mechanism in accordance with the difference.

The object and advantages of the embodiment will be realized and attained by means of the elements and combinations particularly pointed out in the appended claims. It is to be understood that both the foregoing general description and the following detailed description are exemplary and explanatory and are not restrictive of the embodiment, as claimed.

### BRIEF DESCRIPTION OF THE DRAWINGS

FIG. 1 is a plan view schematically illustrating the structure of a hard disk drive as a specific example of a storage apparatus;

FIG. 2 is a partial plan view of a magnetic recording disk;

FIG. 3 is an enlarged partial plan view of the magnetic recording disk;

FIG. 4 is an enlarged partial plan view of the magnetic recording disk;

FIG. 5 is an enlarged partial plan view of the magnetic recording disk;

FIG. 6 is an enlarged partial sectional view taken along the line 6-6 in FIG. 3;

FIG. 7 is a block diagram schematically illustrating a control system of tracking servo;

FIG. 8 is an enlarged partial plan view of the magnetic recording disk for depicting the movement path of a read element;

FIG. 9 is a graph depicting the waveform of output from the read element;

FIG. 10 is a graph depicting the waveform of the absolute values of output from the read element;

FIG. 11 is an enlarged partial plan view of the magnetic recording disk for depicting the movement path of the read element;

FIG. 12 is a graph depicting the waveform of output from the read element;

FIG. 13 is a graph depicting the waveform of the absolute values of the output values from the read element;

FIG. 14 is an enlarged partial plan view of the magnetic recording disk for depicting the movement path of the read element;

FIG. 15 is a graph depicting the waveform of output from the read element;

FIG. 16 is a graph depicting the waveform of the absolute values of the output values from the read element;

FIG. 17 is a schematic view schematically illustrating a recording track on the magnetic recording disk; and

FIG. 18 is a graph depicting the waveform of output from the read element and the waveform of the absolute values of the output.

### DESCRIPTION OF EMBODIMENT

An embodiment of the present invention will be explained below with reference to the accompanying drawings.

FIG. 1 schematically illustrates the structure of a hard disk drive, HDD, 11 as an example of a storage medium drive or storage apparatus. The hard disk drive 11 includes an enclosure 12. The enclosure 12 includes an enclosure cover, not depicted, and a box-shaped enclosure base 13 defining an inner space in the shape of a flat parallelepiped, for example. The box-shaped enclosure base 13 may be made of a metallic material such as aluminum (Al), for example. Molding process may be employed to form the box-shaped enclosure base 13. The enclosure cover is coupled to the box-shaped enclosure base 13. The enclosure cover closes the opening of the box-shaped enclosure base 13. Pressing process may be employed to form the enclosure cover out of a plate material, for example.

A printed wiring board, not depicted, is attached to the outer side of the box-shaped enclosure base 13. Large-scale integrated circuit (LSI) chips such as a central processing unit (CPU) and a hard disk controller (HDC) as well as connectors are mounted on the printed wiring board. The central processing unit and the hard disk controller serve to control the operation of the hard disk drive 11. The connectors receive therein a control signal cable and a power supply cable extending from a main board of a host computer, for example. The central processing unit and the hard disk controller operate in response to the supply of electric power through the power supply cable.

At least one magnetic recording disk 14 as a storage medium is placed in the inner space of the box-shaped enclosure base 13. The magnetic recording disk or disks 14 are mounted on the driving shaft of a spindle motor 15. The spindle motor 15 drives the magnetic recording disk or disks 14 for rotation at a higher revolution speed such as 5,400 rpm, 7,200 rpm, 10,000 rpm, 15,000 rpm, or the like. The magnetic recording disk 14 is a so-called vertical magnetic recording medium, as described later in detail.

A driving mechanism, namely a carriage 16, is also placed in the inner space of the box-shaped enclosure base 13. The carriage 16 includes a carriage block 17. The carriage block 17 is coupled to a vertical pivotal shaft 18 for relative rotation. The vertical pivotal shaft stands upright from the bottom plate of the box-shaped enclosure base 13. Carriage arms 19 are defined in the carriage block 17. The carriage arms 19 extend in a horizontal direction from the vertical pivotal shaft 18. The carriage block 17 may be made of aluminum (Al), for example. Extrusion process may be employed to form the carriage block 17, for example.

A head suspension 21 is attached to the front or tip end of the individual carriage arm 19. The head suspension 21 extends forward from the carriage arm 19. A flexure is attached to the head suspension 21. A flying head slider 22 is supported on the flexure. The flexure allows the flying head slider 22 to change its attitude relative to the head suspension 21. A head element, namely an electromagnetic transducer, not depicted, is mounted on the flying head slider 22.

The electromagnetic transducer includes a write element and a read element, for example. A so-called single pole head is employed as the write element. The single pole head generates a magnetic field with the assistance of a thin film coil pattern. A main magnetic pole and an auxiliary magnetic pole allow the magnetic flux to circulate between the single pole head and the magnetic recording disk 14. The magnetic field is in this manner guided in the vertical direction perpendicular to the surface of the magnetic recording disk 14. The magnetic field is utilized to write binary data into the magnetic recording disk 14. A giant magnetoresistive (GMR) element or a tunnel-junction magnetoresistive (TMR) element is employed as the read element. A variation in the electric resistance is induced in a spin valve film or a tunnel-junction film in response to the inversion of polarization in the magnetic field applied from the magnetic recording disk 14, for example. The read element discriminates binary data on the magnetic recording disk 14 based on the induced variation in the electric resistance.

When the magnetic recording disk 14 rotates, the flying head slider 22 is allowed to receive airflow generated along the rotating magnetic recording disk 14. The airflow serves to generate a positive pressure or lift as well as a negative pressure on the flying head slider 22. The lift of the flying head slider 22 is balanced with the urging force of the head suspension 21 and the negative pressure so that the flying head slider 22 keeps flying above the surface of the magnetic recording disk 14 at a higher stability during the rotation of the magnetic recording disk 14.

A voice coil motor, VCM, 23 is coupled to the carriage block 17. The voice coil motor 23 serves to drive the carriage block 17 for rotation around the vertical pivotal shaft 18. The rotation of the carriage block 17 allows the carriage arms 19 and the head suspensions 21 to swing. When the individual carriage arm 19 swings around the vertical pivotal shaft 18 during the flight of the flying head slider 22, the flying head slider 22 is allowed to move in the radial direction of the magnetic recording disk 14. The electromagnetic transducer on the flying head slider 22 is thus allowed to cross the data zone defined between the innermost and outermost recording tracks. The electromagnetic transducer on the flying head slider 22 is in this manner positioned right above a target recording track on the magnetic recording disk 14.

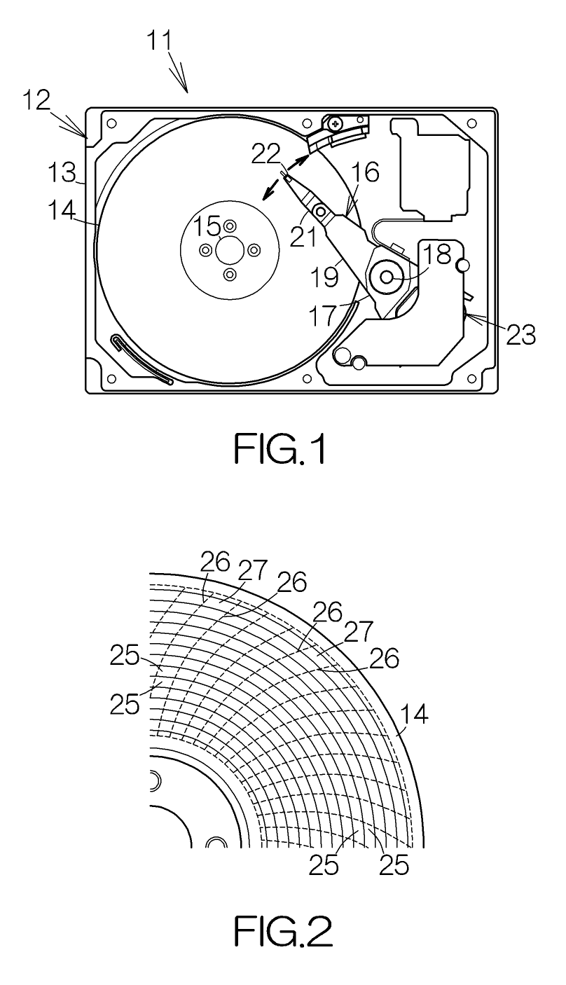

FIG. 2 schematically illustrates the magnetic recording disk 14 according to an embodiment of the present invention. Recording tracks 25, 25, . . . extend on the front and back surfaces of the magnetic recording disk 14 in the circumferential direction, namely the down-track direction, of the magnetic recording disk 14. The recording tracks 25 are arranged in a concentric pattern. Stripes of curved servo areas or sectors 26, for example, sixty of those, are defined on the front and back surfaces of the magnetic recording disk 14. The curved servo sectors 26 extend in the radial direction. The curvature of the curved servo sectors 26 is set consistent with the movement path of the electromagnetic transducer. A data area or sector 27 is established between adjacent ones of the curved servo sectors 26. The curved servo sectors 26 and the data sectors 27 are thus alternately defined on the individual recording track 25 in the circumferential direction of the magnetic recording disk 14. Binary data has been stored in the curved servo sectors 26 for positioning the electromagnetic transducer on the flying head slider 22.

As depicted in FIG. 3, magnetic dots 28 arranged in the individual recording track 25 in the down-track direction at constant intervals. The individual magnetic dot 28 is shaped in a column having the center axis perpendicular to the surface of the magnetic recording disk 14, for example, for establishment of a magnetic pillar. The diameter of the magnetic dots 28 is set at 20 nm approximately, for example. The individual magnetic dot 28 is magnetized in the upward (or outward) direction or in the downward (or inward) direction along the perpendicular direction perpendicular to the surface of the magnetic recording disk 14. Binary data is in this manner recorded into the individual magnetic dot 28. A nonmagnetic body 29 is utilized to magnetically insulate or isolate the magnetic dots 28 from one another. The magnetic dots 28 are placed in the curved servo sectors 26 and the data sectors 27.

The magnetic dots 28 of the individual recording track 25 are spaced from one another at intervals equal to the diameter of the magnetic dots 28. The magnetic dots 28 in the arbitrary one of the recording tracks 25 are dislocated in the down-track direction relative to the corresponding magnetic dots 28 of the adjacent recording track 25. For example, the central axes of the magnetic dots 28 on the recording tracks 25 on the opposite sides of the arbitrary one of the recording tracks 25 are located on the radius of the magnetic recording disk 14 at the middle between the central axes of the adjacent magnetic dots 28, namely, the leading and trailing magnetic dots, on the arbitrary one of the recording tracks 25 at the intermediate position between the outermost and innermost recording tracks 25, namely at and around a halfway position between the outermost and innermost recording tracks 25. A boundary 31 is defined between the adjacent ones of the recording tracks 25. The magnetic dots 28 of the adjacent ones of the recording tracks 25 are alternately arranged along the boundary 31 in a staggered pattern. The boundaries 31 extend in the down-track direction of the magnetic recording disk 14.

A read element 32 of the flying head slider 22 is designed to follow one of the boundaries 31. When the centerline CL of the read element 32 is aligned with the boundary 31, on-track is realized. The interval between edges 32a, 32a of the read element 32, namely a core width CW, is set equal to or larger than a track width TW of the recording track 25 defined in the cross-track direction. The core width CW is also set smaller than twice the track width TW. Here, the core width CW is set 1.5 times as large as the track width TW. The track width TW is set equal to the diameter of the magnetic dots 28. When the read element 32 follows the boundary 31, the read element 32 alternately receives magnetic fields from the magnetic dots 28 of the two adjacent recording tracks 25. Since the magnetic dots 28 are alternately arranged along the boundary 31 in the staggered pattern, the read element 32 is allowed to read binary data from the magnetic dots 28 one by one in sequence. A reading process will be described later in detail.

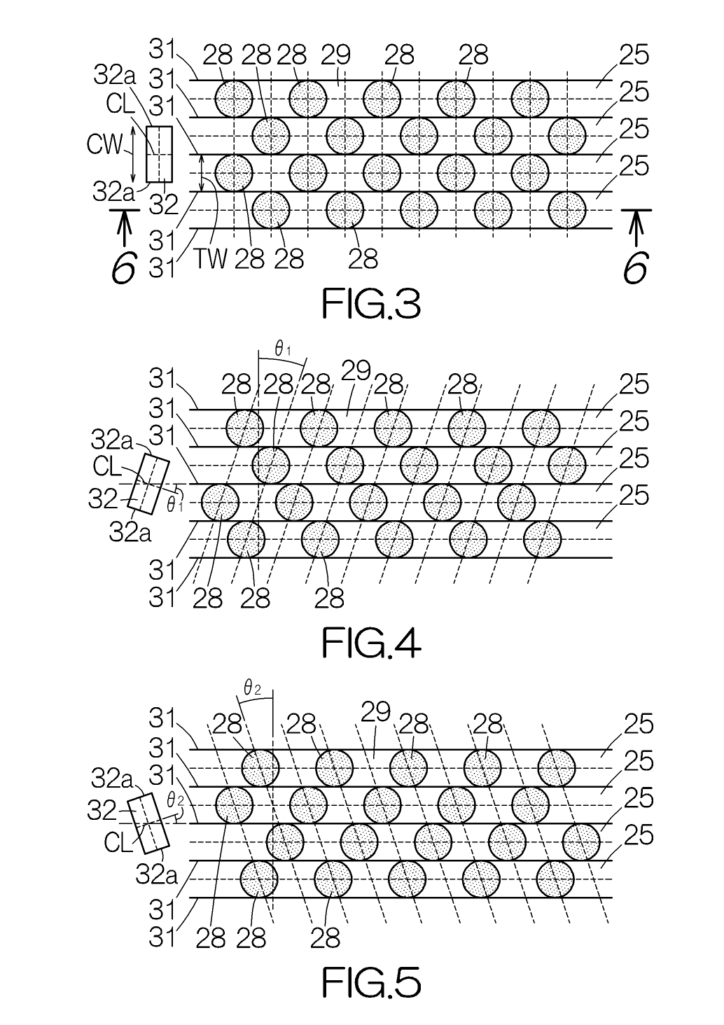

As depicted in FIG. 4, the flying head slider 22, namely the read element 32, is subjected to a skew angle θ₁ on any one of the recording tracks 25 near the outer periphery of the magnetic recording disk 14, for example. The skew angle θ₁ is an intersection angle between the centerline CL of the read element 32 and the boundary 31. The central axes of the magnetic dots 28 on the recording tracks 25 on the opposite sides of the arbitrary one of the recording tracks 25 near the outer periphery of the magnetic recording disk 14 are located on the crossline intersecting the radius of the magnetic recording disk 14 by the intersection angle θ₁ at the middle between the central axes of the adjacent magnetic dots 28, namely, the leading and trailing magnetic dots, on the arbitrary one of the recording tracks 25. The magnetic dots 28 of the recording track 25 are in this manner dislocated in the down-track direction relative to the corresponding magnetic dots 28 of the adjacent recording track 25 by an amount depending on the skew angle θ₁. The intervals are set uniform between the adjacent magnetic dots 28 on the individual recording track 25 on the magnetic recording disk 14.

Likewise, the flying head slider 22, namely the read element 32, is subjected to a skew angle θ₂ on any one of the recording tracks 25 near the center of the magnetic recording disk 14, for example. The central axes of the magnetic dots 28 on the recording tracks 25 on the opposite sides of the arbitrary one of the recording tracks 25 near the center of the magnetic recording disk 14 are located on the crossline intersecting the radius of the magnetic recording disk 14 by the intersection angle θ₂ at the middle between the central axes of the adjacent magnetic dots 28, namely, the leading and trailing magnetic dots, on the arbitrary one of the recording tracks 25. The magnetic dots 28 of the recording track 25 are in this manner dislocated in the down-track direction relative to the corresponding magnetic dots 28 of the adjacent recording track 25 by an amount depending on the skew angle θ₂. The skew angle θ₂ is set symmetry to the skew angle θ₁ relative to the circumferential line. The skew angles θ₁, θ₂ increase as the positions get farther from the recording tracks 25 of the aforementioned middle or halfway position toward the outer periphery and the center of the magnetic recording disk 14, respectively. The amount of the dislocation of the magnetic dots 28 in the down-track direction may be set for the individual recording track 25 in accordance with the skew angles θ₁, θ₂.

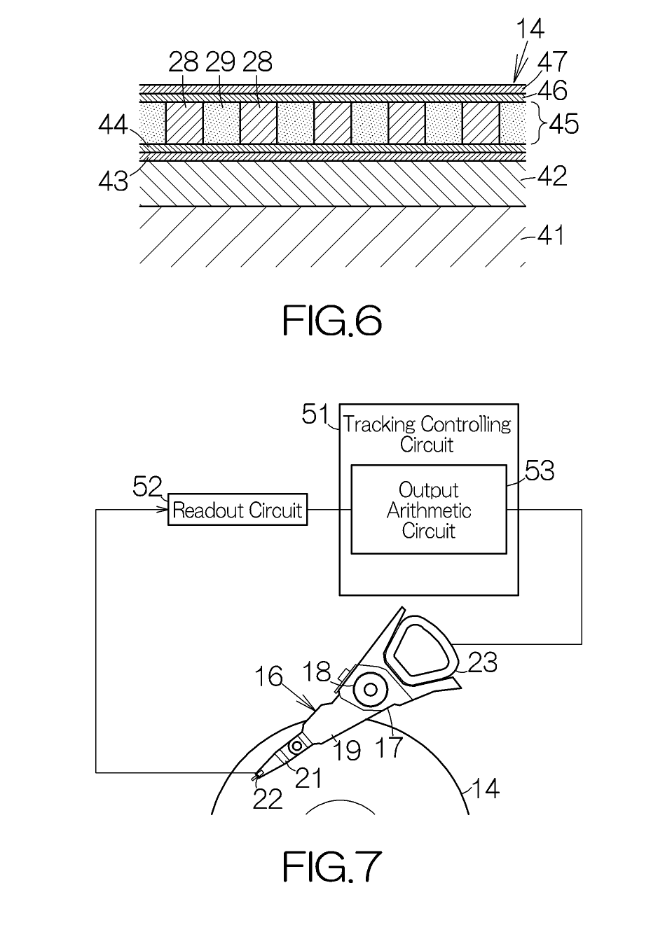

As depicted in FIG. 6, the magnetic recording disk 14 includes a substrate 41. A glass substrate is employed as the substrate 41, for example. An underlayer 42 extends over the surface of the substrate 41. The underlayer 42 may be made of a soft magnetic material such as an iron carbide tantalum (FeTaC) film, a nickel iron (NiFe) film, or the like. The axis of easy magnetization is established in the underlayer 42 in the in-plane direction set parallel to the surface of the substrate 41. A tantalum (Ta) cohering layer 43 extends over the surface of the underlayer 42. The Ta cohering layer 43 has the amorphous structure. A ruthenium (Ru) underlayer 44 extends over the surface of the Ta cohering layer 43. The Ru underlayer 44 has the polycrystalline structure. The adjacent ones of crystal grains cohere together.

A magnetic recording layer 45 extends over the surface of the Ru underlayer 44. The aforementioned magnetic dots 28 and the nonmagnetic body 29 are formed in the magnetic recording layer 45. A boundary is defined between the individual magnetic dot 28 and the nonmagnetic body 29 in the vertical direction perpendicular to the surface of the substrate 41. The axis of easy magnetization is established in the magnetic recording layer 45 in the vertical direction perpendicular to the surface of the substrate 41. The magnetic dots 28 are made of cobalt chrome platinum (CoCrPt), for example. The surface of the magnetic recording disk 45 is coated with a protection film 46 such as a diamond-like carbon (DLC) or a lubricant film such as a perfluoropolyether (PFPE) film.

As depicted in FIG. 7, a controller circuit, namely a tracking controlling circuit 51, is incorporated in the hard disk drive 11. The tracking controlling circuit 51 executes tracking servo control in response to signals supplied from the read element 32. The tracking servo control is designed to determine the rotation or pivotal angle of the carriage 16 around the vertical pivotal shaft 18 in accordance with a deviation between the centerline CL of the read element 32 on the flying head slider 22 and one of the boundaries 31. The carriage 16 is configured to move the flying head slider 22 toward a target one of the boundaries 31. The tracking servo control allows the centerline CL of the read element 32 to follow the boundary 31 of the magnetic recording disk 14.

The signal of the read element 32 is supplied to the tracking controlling circuit 51 from a readout circuit 52. A sensing current is supplied to the read element 32 from the readout circuit 52. The voltage of the sensing current reflects a variation in the electric resistance of the read element 32. Signals generated based on the variation in the voltage are supplied to an output arithmetic circuit 53. The output arithmetic circuit 53 detects a variation in the output value of the signal from the readout circuit 52. The output arithmetic circuit 53 generates positional information specifying the position of the read element 32 based on the detected variation. The positional information is utilized to generate a control signal. The control signal is supplied to the voice coil motor 23. The voice coil motor 23 drives the carriage 16 for rotation around the vertical pivotal shaft 18 in accordance with the intensity of the control signal. The rotation of the carriage 16 serves to eliminate a deviation between the centerline CL of the read element 32 and the boundary 31. The tracking servo control is in this manner realized.

In the case where the centerline CL of the read element 32 follows one of the boundaries 31, the read element 32 is equally assigned to the adjacent recording tracks 25 on both sides of the boundary 31. The read element 32 during the on-track status reads out signals of the identical output intensity from the magnetic dots 28 of the adjacent recording tracks 25. In the case where the centerline CL of the read element 32 deviates from the boundary 31 toward one of the adjacent recording tracks 25, the read element 32 has a larger area opposed to the magnetic dot 28 on one of the adjacent recording tracks 25 as compared with the case of the on-track. The read element thus receives signals of an increased output intensity from the opposed magnetic dots 28 on one of the adjacent recording tracks 25. Simultaneously, the read element 32 has a smaller area opposed to the magnetic dot 28 on the other of the adjacent recording tracks 25 as compared with the case of the on-track. The read element 32 thus receives signals of a reduced output intensity from the opposed magnetic dots 28 on the other of the adjacent recording tracks 25. In the case where the edges 32a, 32a of the read element 32 are kept within the adjacent recording tracks 25, the output intensity of signals detected at the read element 32 depends on the position of the read element 32 in the radial direction.

When the write element, namely a single pole head, is opposed to the surface of the magnetic recording disk 14, the main magnetic pole serves to apply a magnetic field to the magnetic recording layer 45 at the individual magnetic dot 28. The magnetic flux is directed to the magnetic recording layer 45 in the vertical direction perpendicular to the surface of the magnetic recording layer 45. The magnetic flux runs through the underlayer 42 and returns to the auxiliary magnetic pole of the single magnetic pole. An upward (vertically-outward) magnetization or a downward (vertically-inward) magnetization is established in the magnetic recording layer 45 for the individual magnetic dot 28. Binary data is in this manner recorded. When the read element 32 is opposed to the surface of the magnetic recording disk 14, the magnetic recording layer 45 inside the individual magnetic dot 28 serves to leak a magnetic field to the spin valve film or a tunnel-tunnel junction film of the read element 32. A variation in the electric resistance of the spin valve film or the tunnel-junction film is thus induced. The variation in the electric resistance is utilized to discriminate binary data on the magnetic recording disk 14.

Now, assume that the centerline CL of the read element 32 is positioned right above a specific one of the boundaries 31 during the rotation of the magnetic recording disk 14. The read element 32 follows the boundary 31 at the middle position in the radial direction of the magnetic recording disk 14, for example, as depicted in FIG. 8. Here, in the case where the upward magnetization is established, a positive signal is read out. In the case where the downward magnetization is established, a negative signal is read out. The positive signal and the negative signal correspond to “1” and “0” or “0” and “1”, respectively. When the read element 32 is positioned above any one of the curved servo sectors 26, the read element 32 is alternately subjected to the magnetic fields from the magnetic dots 28 on the adjacent recording tracks 25 on both sides of the boundary 31.

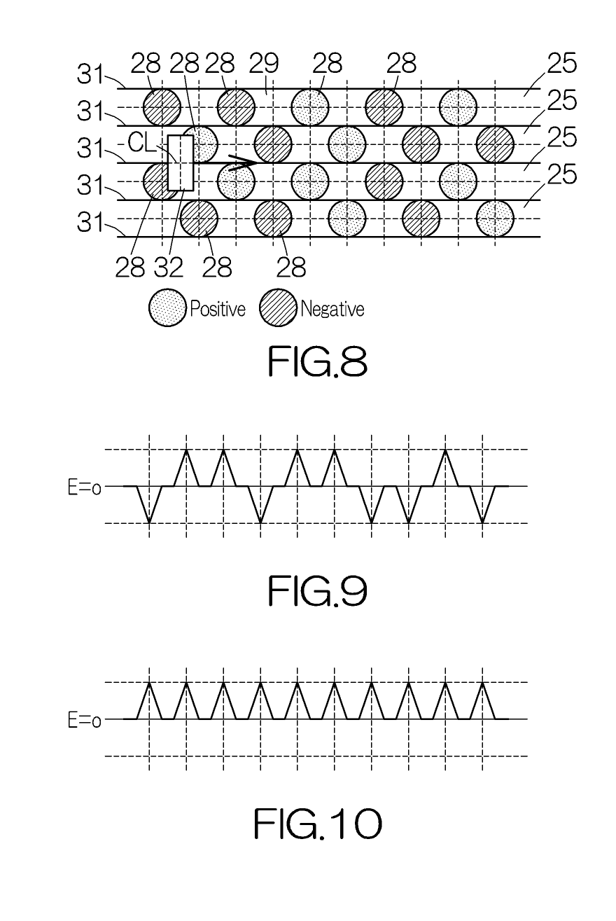

As depicted in FIG. 9, positive and negative outputs are detected as a result. Since the centerline CL of the read element 32 is positioned right above the boundary 31, the read element 32 receives outputs of the equal intensity from the magnetic dots 28 of the adjacent recording tracks 25. This results in uniform absolute values of the outputs generated based on the magnetic dots 28 on the adjacent recording tracks 25, as depicted in FIG. 10. The output arithmetic circuit 53 detects the difference equal to “zero” between the output from one of the adjacent recording tracks 25 and the output from the other of the adjacent recording tracks 25. Accordingly, as long as the difference takes the value of “zero”, it is confirmed that the centerline CL of the read element 32 is positioned right above the boundary 31.

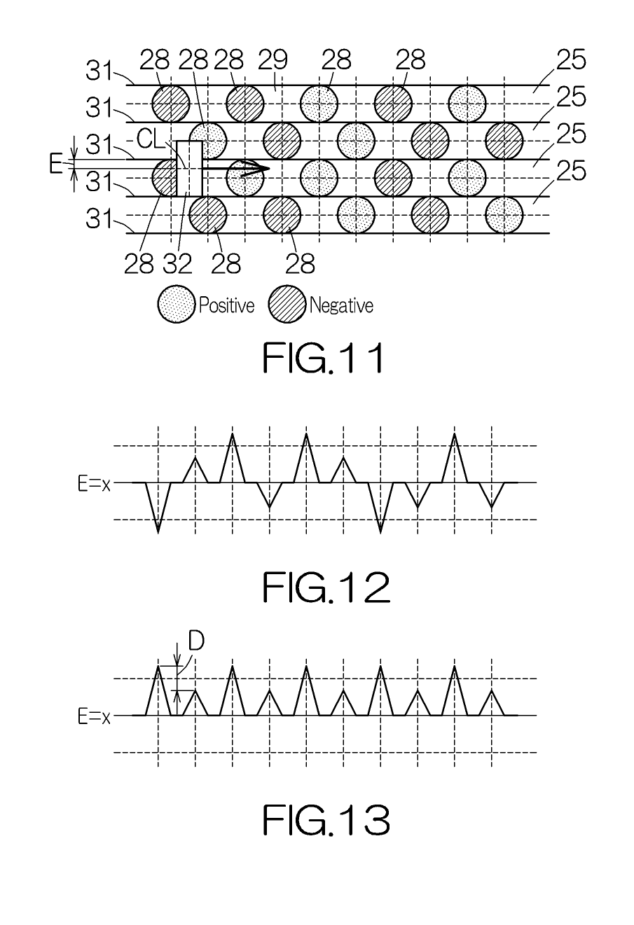

The read element 32 suffers from a deviation from the boundary 31 in the radial direction in response to the vibration of the flying head slider 22 and/or the magnetic recording disk 14 or other factors, for example. Assume that the centerline CL of the read element 32 deviates from the boundary 31 in the radial direction toward the outer periphery of the magnetic recording disk 14, as depicted in FIG. 11. The read element 32 follows the boundary 31 in the same manner as described above. As depicted in FIG. 12, the read element 32 receives outputs of an increased intensity from the outside one of the adjacent recording tracks 25 and outputs of a reduced intensity from the inside one of the adjacent recording tracks 25. As depicted in FIG. 13, a difference D is generated between the absolute values of the outputs from the magnetic dots 28 on the adjacent recording tracks 25. The output arithmetic circuit 53 calculates the difference D between the output from the outside recording track 25 and the output from the inside recording track 25. The calculated difference D corresponds to a deviation E between the centerline CL of the read element 32 and the boundary 31. The output arithmetic circuit 53 generates positional information specifying the position of the read element 32 in the radial direction of the magnetic recording disk 14. A correlation may beforehand be calculated between the difference D and the deviation E.

The generated positional information is utilized to generate a control signal. The control signal is supplied to the voice coil motor 23. The voice coil motor 23 drives the carriage 16 for rotation in accordance with the intensity of the control signal. The centerline CL of the read element 32 is in this manner positioned right above the boundary 31. The single pole head is allowed to effect the writing operation over the data sector 27 in this situation. The single pole head writes binary data into the individual magnetic dot 28 in the data sector 27. Likewise, the read element 32 reads binary data from the individual magnetic dot 28 in the data sector 27. In this manner, the read element 32 is positioned based on the curved servo sectors 26 so as to perform the reading operation over the data sectors 27.

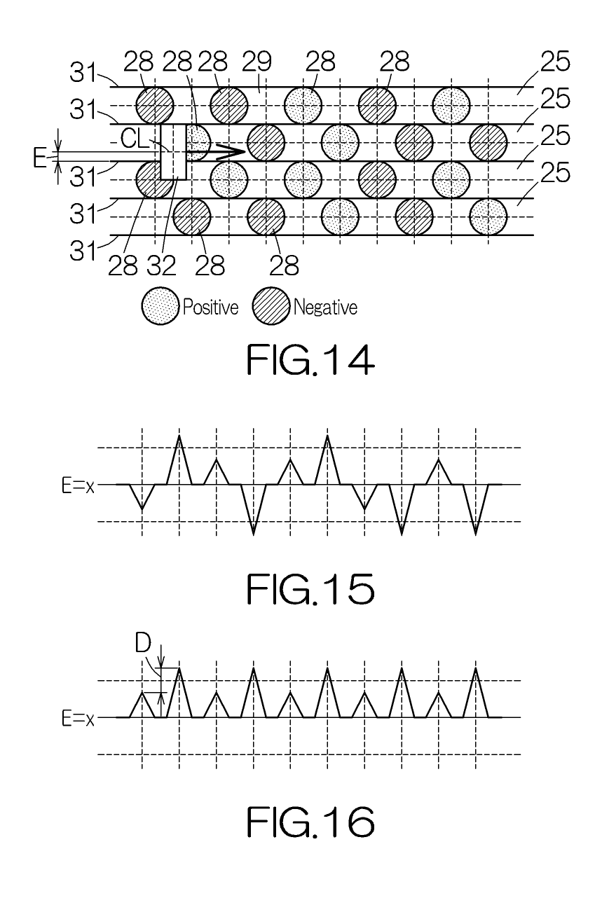

Next, assume that the centerline CL of the read element 32 deviates from the boundary 31 in the radial direction toward the center of the magnetic recording disk 14, as depicted in FIG. 14. The read element 32 follows the boundary 31 in the same manner as described above. As depicted in FIG. 15, the read element 32 receives outputs of a reduced intensity from the outside one of the adjacent recording tracks 25 and outputs of an increased intensity from the inside one of the adjacent recording tracks 25. As depicted in FIG. 16, a difference D is generated between the absolute values of the outputs from the magnetic dots 28 on the adjacent recording tracks 25. The output arithmetic circuit 53 calculates the difference D between the output from the outside recording track 25 and the output from the inside recording track 25. The calculated difference D corresponds to a deviation E between the centerline CL of the read element 32 and the boundary 31. The output arithmetic circuit 53 generates positional information specifying the position of the read element 32 in the radial direction. The centerline CL of the read element 32 is then positioned right above the boundary 31 in the same manner as described above. It should be noted that the same process is performed at areas near the center and the outer periphery of the magnetic recording disk 14.

The hard disk drive 11 allows the read element 32 to follow a specific one of the boundaries 31 for tracking servo control. In the case where the centerline CL of the read element 32 deviates from the boundary 31, the difference D is generated between the outputs from the adjacent recording tracks 25. The difference D is utilized to calculate the deviation E between the centerline CL and the boundary 31. Positional information is generated based on the deviation E. The generated positional information is utilized to generate a control signal for the carriage 16. The centerline CL of the read element 32 is in this manner allowed to keep following the boundary 31. The read element 32, namely the electromagnetic transducer, is positioned right above the magnetic recording disk 14 with accuracy.

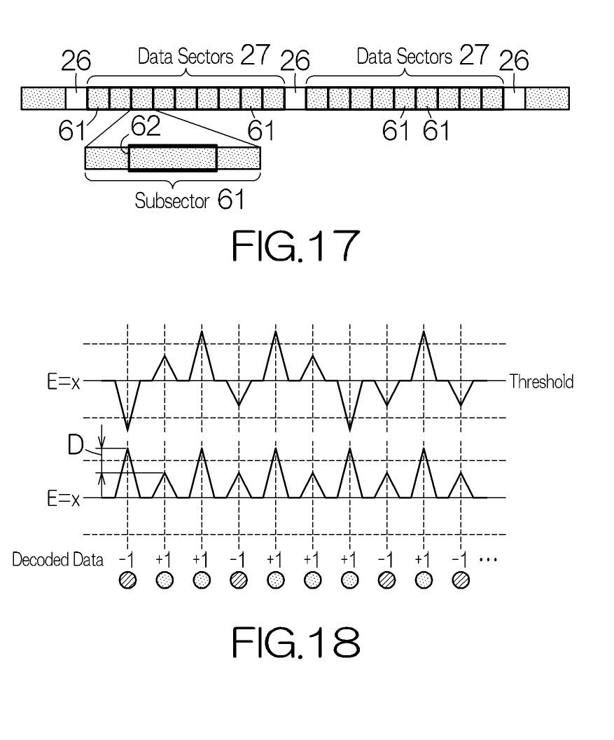

The hard disk drive 11 may be configured to position the read element 32 right above a specific one of the recording tracks 25 based on the data sectors 27. As depicted in FIG. 17, the individual data sector 27 is divided into subsectors 61 in the magnetic recording disk 14. Here, the individual data sector 27 is divided into nine subsectors 61. The magnetic dots 28 of a predetermined number are arranged in the individual subsector 61. The tracking controlling circuit 51 selects one of the subsectors 61 to be used for positioning. In this case, an area 62 may be selected within the subsector 61. The area 62 is a partial area of the subsector 61. The selection of the subsectors 61 and the determination of the range of the area 62 may depend on the quantity of the processes other than the positioning process performed in the hard disk drive 11. If the quantity of the processes other than the positioning process is large, for example, the selected area 62 may occupy a smaller range of the subsector 61. In this manner, plural processes can simultaneously be performed in the hard disk drive 11 with efficiency.

The hard disk drive 11 may simultaneously perform the process of positioning the read element 32 and the process of decoding signals over the data sector 27. The read element 32 follows the boundary 31. The read element 32 reads binary data from the magnetic dots 28 of the adjacent recording tracks 25. As depicted in FIG. 18, a positive or negative output is detected for each of the magnetic dots 28. In this case, the output “0” is set at the threshold of the signal. An output larger than the threshold is positive. An output smaller than the threshold is negative. In this manner, it is detected whether the individual magnetic dot 28 is positive or negative based on the output value of a signal from the magnetic dot 28. Binary data is discriminated. Simultaneously, the absolute value of the output of a signal from the individual magnetic dot 28 is calculated in the same manner as described above. If the centerline CL of the read element 32 deviates from the boundary 31, the difference D is generated between the absolute values. The aforementioned process is then performed.

All examples and conditional language recited herein are intended for pedagogical purposes to aid the reader in understanding the invention and the concept contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A method of detecting position of a head, comprising:
making a relative movement between a head and first and second recording tracks along a boundary between the first recording track and the second recording track, the first recording track including first magnetic dots arranged in a down-track direction at constant intervals, the second recording track including second magnetic dots arranged in the down-track direction at constant intervals identical to the intervals of the first magnetic dots, the second magnetic dots being dislocated in the down-track direction relative to the first magnetic dots; and
generating positional information specifying position of the head based on a difference between a first output of signals read from the first magnetic dots and a second output of signals read from the second magnetic dots.

2. The method according to claim 1, wherein the head has a core width equal to or larger than a track width of the first recording track, the core width being smaller than twice the track width of the first recording track.

3. The method according to any one of claim 1, wherein the recording track includes data area to store magnetic information and servo area to store magnetic positioning information for the head at a position adjacent to the data area, the head reads signals from the first and second magnetic dots in the data area to generate the positional information.

4. The method according to claim 3, wherein the data area is divided into subsectors, a target subsector or subsectors being selected from the subsectors to generate the positional information.

5. The method according to claim 3, wherein the signals are read from the first and second magnetic dots in the data area while the positional information is concurrently generated.

6. The method according to claim 1, wherein the second magnetic dots are dislocated in the down-track direction by an amount of dislocation determined based on a skew angle of the head.

7. A storage apparatus comprising:
a storage medium including a first recording track and a second recording track adjacent to the first recording track, the first recording track including first magnetic dots arranged in a down-track direction at constant intervals, the second recording track including second magnetic dots arranged in the down-track direction at constant intervals identical to the intervals of the first magnetic dots, the second magnetic dots being dislocated in the down-track direction relative to the first magnetic dots;
a head opposed to the storage medium, the head configured to read signals from the first and second magnetic dots;
a driving mechanism supporting the head, the driving mechanism moving the head in a cross-track direction of the first and second recording tracks; and
a controller circuit determining a difference between a first output of the signals read from the first magnetic dots and a second output of the signals read from the second magnetic dots, the first and second outputs being supplied from the head moving relative to the storage medium along a boundary between the first recording track and the second recording track, the controller circuit controlling operation of the driving mechanism in accordance with the difference.
